(19) United States
(12) Patent Application Publication
(10) Pub. No.: US 2025/0303769 A1
(43) Pub. Date: Oct. 2, 2025

(54) IMAGE FORMING SYSTEM

(71) Applicant: CANON KABUSHIKI KAISHA, Tokyo (JP)

(72) Inventor: OSAMU SATO, Tokyo (JP)

(21) Appl. No.: 19/096,236

(22) Filed: Mar. 31, 2025

(30) Foreign Application Priority Data
Apr. 2, 2024 (JP) 2024-059674
Dec. 2, 2024 (JP) 2024-209797

(51) Int. Cl. B41J 29/393; B41J 29/377

(52) U.S. Cl. CPC B41J 29/393; B41J 29/377

(57) ABSTRACT

An image forming system includes a plurality of modules, the image forming system includes a first module, a second module, the first module and the second module being arranged along a conveying direction in which a sheet in the first module is conveyed, a first electric component module coupled to the first module, the first electric component module being arranged, with respect to the first module, in a crossing direction that intersects the conveying direction, a main body-side electric component unit provided in the first module, a first electric component unit provided in the first electric component module, and a connection cable provided between the first module and the first electric component module.

### BACKGROUND

### Field

The present disclosure relates to an image forming system for forming an image on a recording material by using an ink-jet system or an electrophotographic system.

### Description of the Related Art

As disclosed in Japanese Patent Application Laid-open No. 2022-88820, an image forming system to be used in commercial printing or the like may be formed of a combination of a plurality of modules having different functions. Each of the modules includes an electric component unit for use in controlling an operation of a built-in component. The electric component units of the plurality of modules are electrically connected to each other by a connection cable in order to, for example, transmit and receive a control signal or supply electric power. The electric component unit is provided with a dedicated protection cover different from a rear cover in order to protect the electric component unit and the connection cable. Preparation of a dedicated protection cover increases cost. A user may remove and mount the protection cover in addition to the rear cover at the time of installation and maintenance of an image forming apparatus.

The image forming system includes the plurality of modules, and hence the number of cables for connecting those modules may increase. In Japanese Patent Application Laid-open No. 2022-88820, in order to protect the cable, a dedicated protection cover different from a rear cover is provided so that a space for arranging the cable is ensured. However, in the related art, there is a possibility that the space for arranging a larger number of cables becomes insufficient. Further, the maintenance efficiency and the heat exhaust efficiency from the inside are reduced depending on the arrangement of the cables.

### SUMMARY

An image forming system according to some embodiments includes a plurality of modules, the image forming system includes a first module, a second module, the first module and the second module being arranged along a conveying direction in which a sheet in the first module is conveyed, a first electric component module coupled to the first module, the first electric component module being arranged, with respect to the first module, in a crossing direction that intersects the conveying direction, a main body-side electric component unit provided in the first module, a first electric component unit provided in the first electric component module, and a connection cable provided between the first module and the first electric component module.

Further features of the present disclosure will become apparent from the following description of exemplary embodiments (with reference to the attached drawings).

### BRIEF DESCRIPTION OF THE DRAWINGS

FIG. 1 is a configuration view for illustrating an ink-jet recording system.

FIG. 2 is a perspective view for illustrating the ink-jet recording system as viewed from an upper front side.

FIG. 3 is a perspective view for illustrating the ink-jet recording system as viewed from an upper rear side.

FIG. 4 is a detailed perspective view for illustrating a drying module and an external electric component module as viewed from the upper rear side.

FIGS. 5A and 5B are perspective views for illustrating the drying module in a state without the external electric component module as viewed from the upper rear side.

FIG. 6 is an explanatory diagram for illustrating a connection relationship of electric component modules.

FIGS. 7A, 7B, and 7C are enlarged views of cross sections of a duct and a peripheral part thereof as viewed from diagonally above.

FIG. 8 is an explanatory view for illustrating a connection configuration of a related-art ink-jet recording system.

FIGS. 9A and 9B are cross-sectional views for illustrating the drying module.

FIGS. 10A and 10B are explanatory views for illustrating a configuration in which connection cables are wired inside of a casing of the drying module.

FIG. 11 is a configuration view for illustrating a main control board and a board support.

FIGS. 12A and 12B are cross-sectional views for illustrating the drying module.

### DESCRIPTION OF THE EMBODIMENTS

Now, referring to the accompanying drawings, description is given of various exemplary embodiments, features, and aspects of the present disclosure.

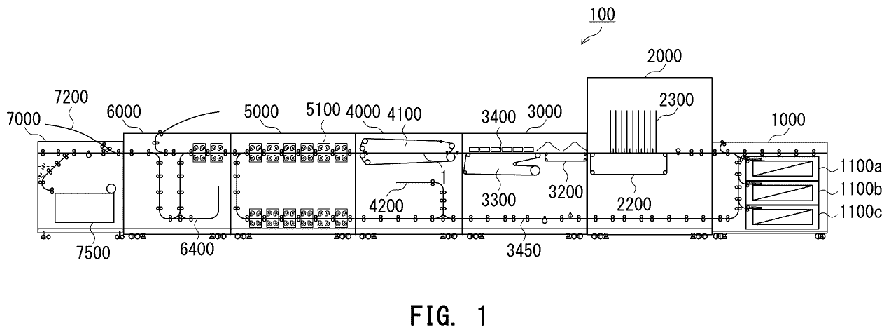

FIG. 1 is a configuration view for illustrating an ink-jet recording system 100 according to an exemplary embodiment. The ink-jet recording system 100 according to this embodiment is a sheet-fed image forming system that forms an ink image on a sheet using two liquids, specifically, a reaction liquid and an ink to produce a product. In this embodiment, a side on which a user stands at the time of operating the ink-jet recording system 100 is referred to as “front side”, and a side opposite to the front side is referred to as “rear side”. A “right-left direction” when the user standing on the front side of the ink-jet recording system 100 sees the ink-jet recording system 100 is a main conveying direction of a sheet in each module. A direction connecting the “front side” and the “rear side” is a “crossing direction” crossing with the sheet conveying direction. The “crossing direction” is sometimes referred to as “front-rear direction”.

The ink-jet recording system 100 includes a sheet feeding module 1000, a printing module 2000, a drying module 3000, a fixing module 4000, a cooling module 5000, a reversing module 6000, and a sheet discharging and stacking module 7000. The sheet feeding module 1000, the printing module 2000, the drying module 3000, the fixing module 4000, the cooling module 5000, the reversing module 6000, and the sheet discharging and stacking module 7000 are arranged side by side in the sheet conveying direction (or along the sheet conveying direction). A sheet being a cut paper-like recording medium on which an image is to be printed is fed from the sheet feeding module 1000, subjected to predetermined processing related to image formation by each module, and discharged to the sheet discharging and stacking module 7000.

The sheet feeding module 1000 includes a plurality of sheet storage portions 1100a to 1100c (three tiers in this embodiment). Each of the sheet storage portions 1100a to 1100c can store sheets therein. Each of the sheet storage portions 1100a to 1100c is configured to be capable of being drawn toward a front side of the apparatus, and sheets are stored in each sheet storage portion after the sheet storage portion is drawn toward the front side of the apparatus. The sheet feeding module 1000 feeds sheets one by one to the printing module 2000. Thus, each of the sheet storage portions 1100a to 1100c includes a separation belt and conveyance rollers. The number of the sheet storage portions 1100a to 1100c is an example, and may be one, two, or four or more.

The printing module 2000 forms an image on a sheet fed from the sheet feeding module 1000. The printing module 2000 includes a pre-image-forming registration correction unit (not shown), a print belt unit 2200, and a recording unit 2300. The pre-image-forming registration correction unit corrects an inclination and a position of the sheet fed from the sheet feeding module 1000, and conveys the sheet to the print belt unit 2200.

The print belt unit 2200 and the recording unit 2300 are arranged on a downstream side of the pre-image-forming registration correction unit in a sheet conveying direction so as to be opposed to each other across a sheet conveyance path. The print belt unit 2200 conveys, through suction, a sheet to be conveyed from the pre-image-forming registration correction unit. The recording unit 2300 is a sheet processing unit that performs recording processing (printing) from above by a recording head to form an image on the sheet conveyed by the print belt unit 2200. The recording head performs printing by ejecting the ink onto the sheet. The sheet is conveyed through suction by the print belt unit 2200, and thus a constant clearance between the recording head and the sheet is maintained.

A plurality of recording heads is arranged along the sheet conveying direction. The recording heads in this embodiment are five line-type recording heads corresponding to four colors of Y (yellow), M (magenta), C (cyan), and K (black), and the reaction liquid. The number of colors and the number of recording heads are not limited to five. As the ink-jet system, a system using a heat generating element, a piezoelectric element, an electrostatic element, or a micro-electro-mechanical-system (MEMS) element can be adopted. The ink of each color is supplied to the recording head from an ink tank (not shown) through an ink tube.

The sheet printed in the recording unit 2300 is conveyed by the print belt unit 2200. An in-line scanner (not shown) is arranged on a downstream side of the recording unit 2300 in the conveying direction. The in-line scanner is used in order to detect misalignment and color density of the image formed on the sheet and to correct an image to be printed.

The drying module 3000 dries the sheet on which the image has been formed by the printing module 2000. The drying module 3000 dries the sheet to reduce a liquid component contained in the ink, thereby improving fixability between the sheet and the ink. The drying module 3000 includes a decoupling unit 3200, a drying belt unit 3300, and a warm air blowing unit 3400.

The sheet printed in the recording unit 2300 of the printing module 2000 is conveyed to the decoupling unit 3200 in the drying module 3000. The decoupling unit 3200 weakly holds and conveys the sheet by air pressure from above and belt friction. This prevents displacement of the remaining portion of the sheet on the print belt unit 2200 under a state in which the sheet extends astride the decoupling unit 3200 and the print belt unit 2200.

The sheet conveyed from the decoupling unit 3200 is conveyed through suction to the drying belt unit 3300, and at the same time, hot air is blown to the sheet from the warm air blowing unit 3400 arranged above the belt to dry the ink application surface (image printed surface). In addition to the hot air blowing method, the drying method may include a combination of a method of irradiating the sheet surface with electromagnetic waves (such as ultraviolet rays and infrared rays) and a conduction heat transfer method through contact of heating elements.

The fixing module 4000 fixes the image on the sheet by heating the sheet dried in the drying module 3000 and by drying the ink. The fixing module 4000 includes a fixing belt unit 4100 including an upper belt unit and a lower belt unit. The fixing module 4000 causes the sheet conveyed from the drying module 3000 to pass between the heated upper belt unit and lower belt unit, and thus causes (fixes) the ink solvent to fully permeate the sheet.

The cooling module 5000 cools the sheet on which the image has been fixed by the fixing module 4000, and thus solidifies the ink softened by heating and suppresses a temperature change of the sheet caused by downstream devices. The cooling module 5000 includes a plurality of cooling units 5100. The plurality of cooling units 5100 cools the high-temperature sheet conveyed from the fixing module 4000. Each cooling unit 5100 is configured to cool a sheet by taking outside air into a cooling box with a fan to increase the pressure in the cooling box, and by exposing the sheet to air blown out from nozzles formed in a conveyance guide. The plurality of cooling units 5100 is arranged on both sides of the conveyance path, and hence can cool the sheet from both sides.

A conveyance path switching unit is provided in the cooling module 5000. The conveyance path switching unit switches conveyance paths for the sheet according to whether the sheet is conveyed to the reversing module 6000 or to a double-sided printing conveyance path to be used for double-sided printing.

During double-sided printing, the sheet is conveyed to the lower conveyance path in the cooling module 5000, and is conveyed through the double-sided printing conveyance paths of the fixing module 4000, the drying module 3000, the printing module 2000, and the sheet feeding module 1000. A double-sided printing conveyance unit of the fixing module 4000 is provided with a first reversing unit 4200 that reverses the front and back surfaces of the sheet. After the sheet is once conveyed to the first reversing unit 4200, the sheet is reversed and conveyed to the drying module 3000 side, and thus the printed surface with the image is reversed. Owing to conveyance of the sheet through the first reversing unit 4200, printing can be performed on the back surface of the sheet. The sheet is then conveyed again to the pre-image-forming registration correction unit, the print belt unit 2200, and the recording unit 2300 of the printing module 2000, and printing is performed on the sheet.

The reversing module 6000 includes a second reversing unit 6400. The reversing module 6000 can reverse, by the second reversing unit 6400, the front and back surfaces of the sheet to be conveyed. Thus, the orientation of the front and back surfaces of the sheet to be discharged can be changed. The sheet discharging and stacking module 7000 includes a top tray 7200 and a stacking unit 7500. The sheet discharging and stacking module 7000 aligns and stacks the sheets conveyed from the reversing module 6000 onto the top tray 7200 or the stacking unit 7500.

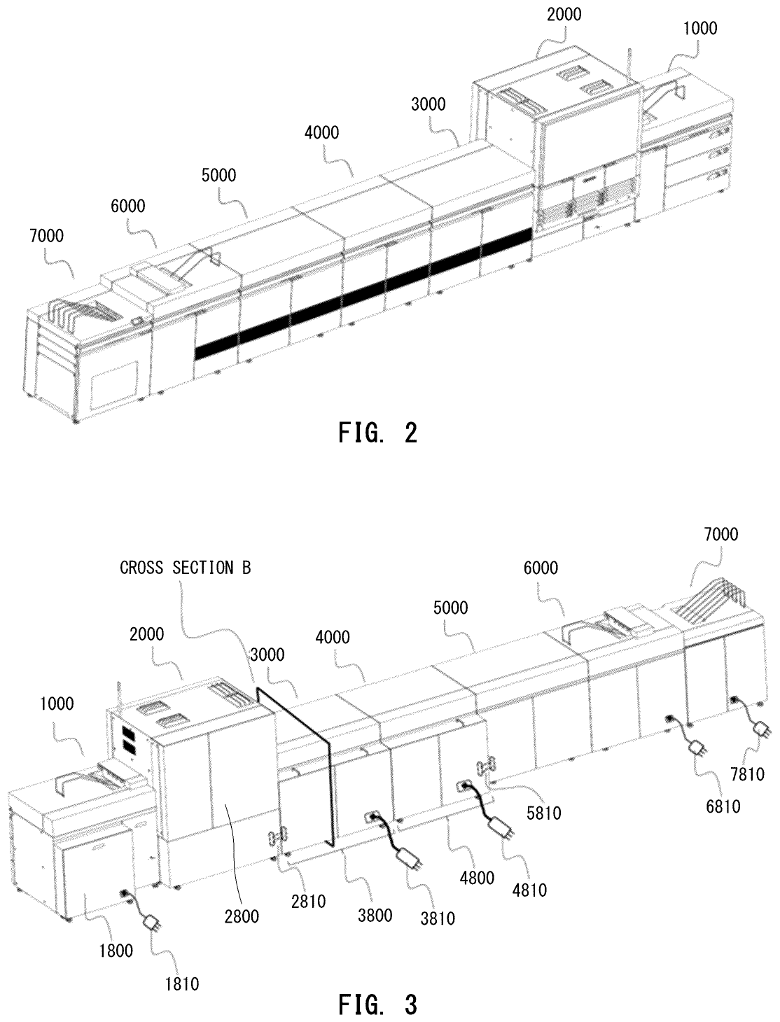

FIG. 2 is a perspective view for illustrating the ink-jet recording system 100 as viewed from the upper front side. FIG. 3 is a perspective view for illustrating the ink-jet recording system 100 as viewed from the upper rear side. External electric component modules 1800, 2800, 3800, and 4800 are mounted on outer sides on the rear side of casings of the sheet feeding module 1000, the printing module 2000, the drying module 3000, and the fixing module 4000, respectively.

The external electric component module corresponding to each module is shipped in a separated state, and is combined and connected at an installation location. That is, the external electric component module corresponding to each module can be separated even after being combined and connected. Four casters may be mounted on a bottom surface of each of the external electric component modules 1800, 2800, 3800, and 4800. With the casters being mounted on each of the external electric component modules 1800, 2800, 3800, and 4800, even under a state in which each of the external electric component modules 1800, 2800, 3800, and 4800 is separated, the external electric component module can be easily moved.

In the following, in some cases, description is given of an example of a pair of a specific module and a corresponding external electric component module. In this case, unless particularly noted, the same holds true also for other modules and corresponding external modules.

A frame of each of the external electric component modules 1800, 2800, 3800, and 4800 is fastened and fixed by screws to the casing of the corresponding one of the sheet feeding module 1000, the printing module 2000, the drying module 3000, and the fixing module 4000. The external electric component modules 1800, 2800, 3800, and 4800 mainly have power supply units and control units mounted thereon, which are incapable of being mounted inside of the casings of the sheet feeding module 1000, the printing module 2000, the drying module 3000, and the fixing module 4000. The external electric component modules 1800, 3800, and 4800 are supplied with alternating current (AC) power from a switchboard of an installation building by power supply cables 1810, 3810, and 4810, respectively. The power supply units and the control units are specific examples of an electric component unit provided in the external electric component module.

The reversing module 6000 and the sheet discharging and stacking module 7000 have power supply units mounted therein, and are not provided with the external electric component module. Thus, the reversing module 6000 and the sheet discharging and stacking module 7000 are supplied with AC power by directly connecting power supply cables 6810 and 7810 to the inside on the rear side.

AC power is supplied to each of the printing module 2000 and the cooling module 5000 from the external electric component module provided on the adjacent module. First, description is given of a power supply cable 2810 (broken line) for supplying AC power to the printing module 2000. An opening is formed in each of a side surface of the external electric component module 2800 of the printing module 2000 and a side surface of the external electric component module 3800 of the adjacent drying module 3000, which face each other. The power supply cable 2810 is arranged through those openings. The power supply cable 2810 is connected to the power supply unit of the external electric component module 3800, and supplies AC power to the printing module 2000 and the external electric component module 2800. AC power is similarly supplied to the cooling module 5000 through use of a power supply cable 5810 (broken line) from the external electric component module 4800 of the fixing module 4000. As described above, the power supply cables 2810 and 5810 are arranged inside of the external electric component modules, and do not pass between the drying module 3000 and the corresponding external electric component module 3800. The power supply cable may be connected to the adjacent module, and hence the power supply cable is arranged so as to pass through the openings of the module side surfaces in order to reduce the length of the power supply cable.

### Drying Module

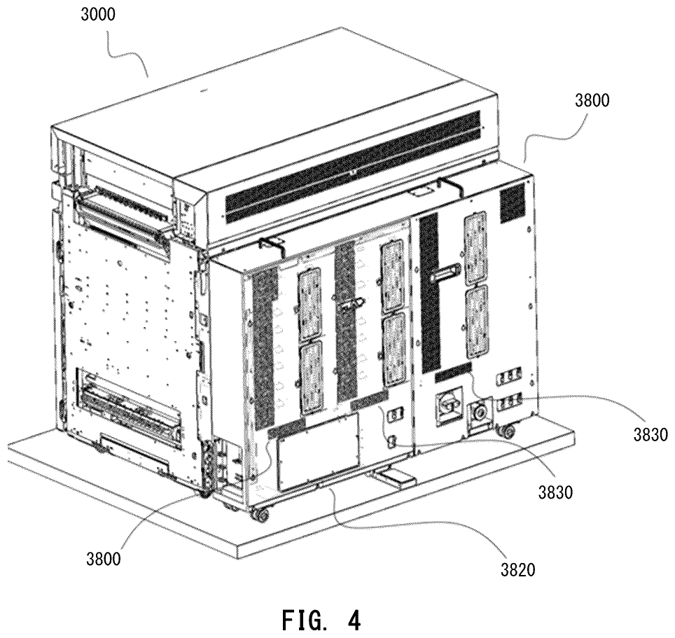

FIG. 4 is a detailed perspective view for illustrating the drying module 3000 and the external electric component module 3800 corresponding to the drying module 3000 as viewed from the upper rear side. The external electric component module 3800 includes a bottom plate 3820 and covers for respective surfaces arranged on the bottom plate 3820. On the cover on the rear side of the external electric component module 3800, a plurality of (in this case, three) louvers 3830 is provided. The louvers 3830 are inlets of air.

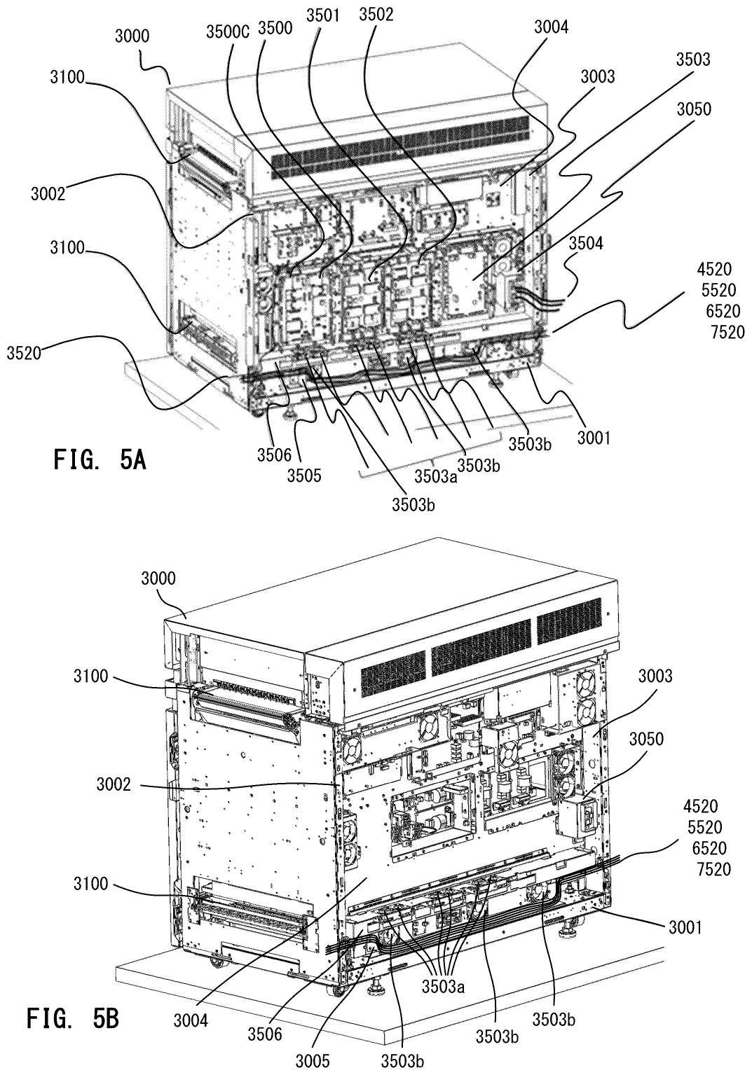

FIGS. 5A and 5B are perspective views for illustrating the drying module 3000 in a state without the external electric component module 3800 as viewed from the upper rear side. FIG. 5A shows a state in which the external electric component module 3800 is removed, and FIG. 5B shows a state in which some elements are removed from FIG. 5A. The drying module 3000 includes a bottom plate 3001, and a rear right column 3002 and a rear left column 3003 supported by the bottom plate 3001. The rear right column 3002 and the rear left column 3003 are each welded and fixed to a corner of the bottom plate 3001 on the rear side. At a position sandwiched between the rear right column 3002 and the rear left column 3003, a rear side plate 3004 is fixed perpendicularly to the bottom plate 3001. A plurality of electric component units is arranged on the rear side of the rear side plate 3004. That is, the electric component unit of the drying module 3000 is arranged on the external electric component module 3800 side (that is, the rear side) in the crossing direction crossing with the sheet conveying direction. An electrical wire bundle 3504 to be connected to the external electric component module 3800 is connected to a connector base 3050 provided on the right side as viewed from the rear side. With the electrical wire bundle 3504, AC power is supplied from the external electric component module 3800 to the drying module 3000.

The AC power supplied from the electrical wire bundle 3504 is converted into a predetermined voltage by a power supply board 3503, and is distributed to each electrical board. Main electrical boards are, from the left as viewed from the rear side, a main control board 3500, a first sub-control board 3501, and a second sub-control board 3502. The first sub-control board 3501 and the second sub-control board 3502 mainly perform motor drive control of conveyance units 3100 for conveying sheets and units for the drying function, which are provided on the front side of the drying module 3000, and detection control of sensors. The units for the drying function are the decoupling unit 3200, the drying belt unit 3300, and the warm air blowing unit 3400 described above. The main control board 3500 gives instructions of operation timings to each board. Each of the main control board 3500, the first sub-control board 3501, the second sub-control board 3502, the power supply board 3503, and the like described above is provided on the rear side of the drying module 3000. The main control board 3500, the first sub-control board 3501, the second sub-control board 3502, the power supply board 3503, and the like are an electric component unit on the main body side (main body-side electric component unit).

Each module other than the drying module 3000 is also provided with at least one main control board to control the operation of the corresponding module. Further, in the printing module 2000, an overall control unit to be described later is provided on any one of the main body of the printing module 2000 and the external electric component module 2800. The overall control unit controls the main control boards of the plurality of modules forming the ink-jet recording system 100 to totally control the ink-jet recording system 100.

### Electrical Connection of Electric Component Modules

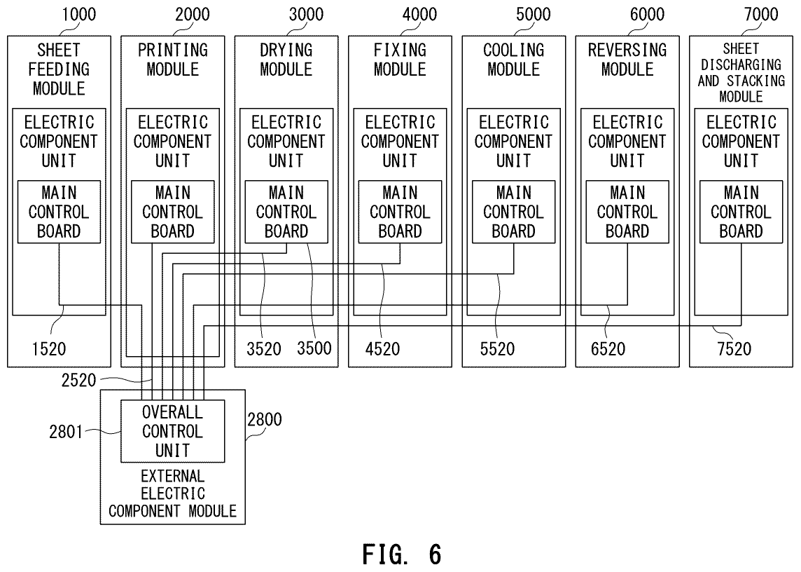

FIG. 6 is an explanatory diagram for illustrating a connection relationship of the electric component modules mounted on the respective modules. To an overall control unit 2801 of the printing module 2000, the connection cables from other modules are collectively connected. In this case, description is given of an example in which the overall control unit 2801 is arranged in the external electric component module 2800. The connection cables from the main control boards of the respective modules are collectively connected to a connection port of the overall control unit 2801.

In order to connect the overall control unit 2801 and each of the plurality of main control boards to each other, as illustrated in FIG. 5A, a plurality of connection cables 3520, 4520, 5520, 6520, and 7520 is provided. Those connection cables are connection cables to be used for transmission of various signals such as a control signal, and for electrically connecting the modules to each other.

The main control board 3500 of the drying module 3000 is connected to the overall control unit of the printing module 2000 by the connection cable 3520. As illustrated in FIG. 5A, in an upper portion of the main control board 3500, a connector port 3500C to which the connection cable 3520 is connected is arranged. The connection cable 3520 is guided downward by being supported by a wire saddle provided at a left edge as viewed from the rear side of the main control board 3500, supported by a wire saddle provided at a lower portion of the rear right column 3002, and is routed to the printing module 2000 side. The connection cable 3520 is mounted after the modules are coupled at the time of installation.

The main control boards of other modules are similarly connected to the overall control unit 2801 by any one of the plurality of connection cables 4520, 5520, 6520, and 7520. For example, one connection cable 4520 connects the main control board arranged in the fixing module 4000 and the overall control unit 2801 to each other. The sheet feeding module 1000 is arranged on a side opposite to the drying module 3000 with reference to the printing module 2000. Accordingly, a connection cable 1520 for connecting the sheet feeding module 1000 and the overall control unit 2801 to each other is not shown in FIG. 5A and FIG. 5B.

In the example of FIG. 6, description has been given of a configuration in which the overall control unit 2801 and the main control board of each of the modules are connected to each other by an individual connection cable, but the electric component unit of each of the external electric component modules may be connected to the overall control unit 2801. For example, the electric component unit provided in the external electric component module 3800 of the drying module 3000 may be connected by the connection cable to the overall control unit 2801 provided in the external electric component module 2800 of the printing module 2000.

In this case, as illustrated in FIG. 3, the drying module 3000 is arranged between the printing module 2000 and the fixing module 4000. Accordingly, the connection cable 4520 for connecting the overall control unit 2801 and the main control board arranged in the fixing module 4000 to each other is arranged so as to pass through the drying module 3000. A part of the connection cable 4520 passing through the drying module 3000 is arranged between the drying module 3000 and the external electric component module 3800 coupled on the rear side of the drying module 3000. The connection cable 4520 is arranged below a lower end of the main control board of the drying module 3000 in the vertical direction crossing with both of the conveying direction and the crossing direction. The connection cable for connecting the overall control unit 2801 and the electric component unit provided in the external electric component module 4800 of the fixing module 4000 is similarly arranged so as to pass through the drying module 3000. This connection cable is also wired so as to pass below the lower end of the main control board of the drying module 3000, between the drying module 3000 and the external electric component module 3800 coupled on the rear side of the drying module 3000.

As described above, a space for the connection cable can be provided between the module main body and the external electric component module. As a result, as illustrated in FIGS. 5A and 5B, a plurality of connection cables can be appropriately arranged. For appropriate arrangement of cables, although there are various viewpoints, for example, the arrangement avoids, for example, forced bending and extreme slack for bypassing a structure. The same holds true also for the connection cables 5520, 6520, and 7520 connected to other main control boards. For example, the connection cable 5520 connected to the cooling module 5000 is arranged so as to pass through the drying module 3000 and the fixing module 4000. A part passing through the fixing module 4000 is arranged below the lower end of the main control board of the fixing module 4000, between the fixing module 4000 and the external electric component module 4800 coupled on the rear side of the fixing module 4000.

In a case where the seven modules are coupled as in this embodiment, the entire length of the ink-jet recording system 100 in the longitudinal direction is close to 9 meters (m), but the connection cable directly connects the main control board and the overall control unit to each other without a relay. In a case where a relay is interposed, a change may be caused in the waveform of the signal transmitted through the connection cable, and a delay may be caused in signal passing. As the connection cable, for example, a 1-Gbps (gigabits per second) class local area network (LAN) cable is suitable. In some cases, the LAN cable of this class is thick. Accordingly, in a case where a LAN cable for a communication speed of 1 Gbps or more is to be used, the effect of this embodiment can be remarkedly obtained.

The connection cables 4520, 5520, 6520, and 7520 passing through the drying module 3000 are held by a cable guide provided on a lower portion of the rear left column 3003 and a cable guide provided on a lower portion of the rear right column 3002. In a region between the rear left column 3003 and the rear right column 3002, the connection cable is restricted and held by a plurality of cable guides on a guide support plate fixed on the bottom plate 3001.

A plurality of fans 3503a is arranged below the main control board 3500, the first sub-control board 3501, and the second sub-control board 3502. Those fans 3503a blow air to mounting surfaces of electrical components of the main control board 3500, the first sub-control board 3501, and the second sub-control board 3502 to cool the electrical components on the mounting surfaces. The fans 3503a are fixed to a duct 3506 for cooling, which is arranged below the main control board 3500, the first sub-control board 3501, and the second sub-control board 3502 in the vertical direction. The duct 3506 is fixed to the rear side plate 3004 so as to occupy the entire width between the rear left column 3003 and the rear right column 3002.

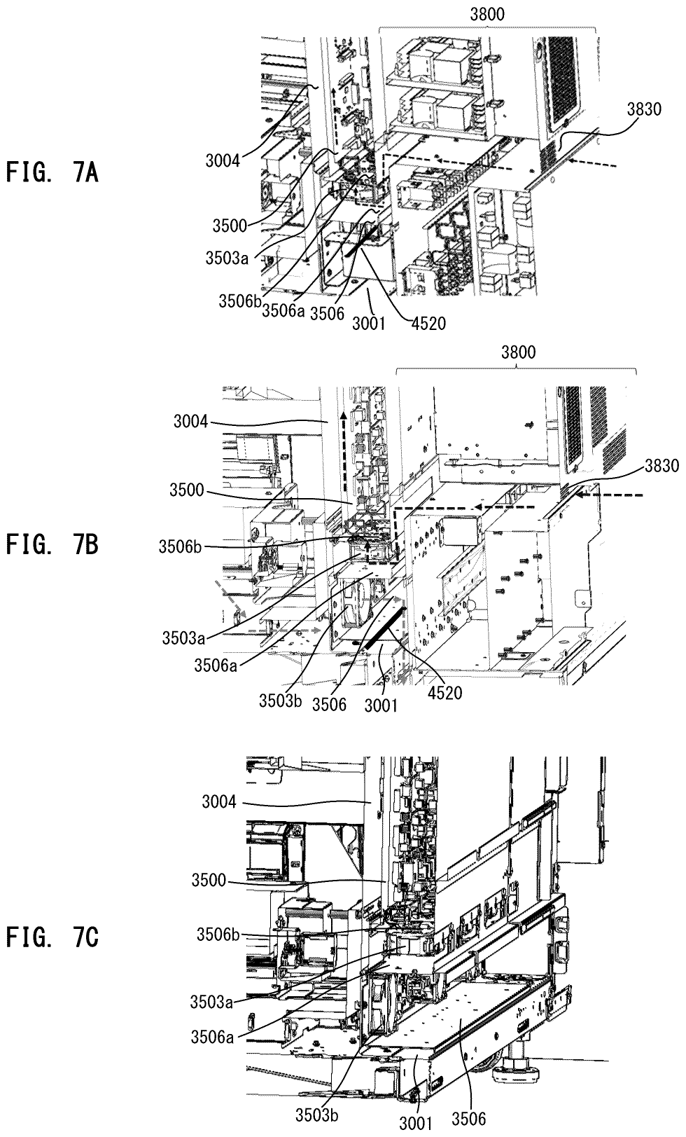

FIGS. 7A, 7B, and 7C are enlarged views of cross sections of the duct 3506 and a peripheral part thereof as viewed from diagonally above. FIG. 7A shows a state in which the cross sections of the duct 3506 and the peripheral part thereof are enlarged. FIG. 7B shows a state in which a plate part of the bottom plate 3001 is removed from FIG. 7A. FIG. 7C shows a state in which the external electric component module 3800 and the connection cable 4520 are removed from FIG. 7B.

In the external electric component module 3800, a louver 3830 is provided as an intake of air. Air taken in from the louver 3830 passes through the inside of the external electric component module 3800 to flow into an entrance opening 3506a of the duct 3506. The axial fan 3503a forcibly discharges the air from an exit opening 3506b provided above an area of a lower portion of the duct 3506 to blow the air to the main control board 3500, the first sub-control board 3501, and the second sub-control board 3502. An airflow path is formed as described above.

Further, the air flowing in from the front side (side opposite to the external electric component module 3800) of the drying module 3000 is sent downward of the drying module 3000 by an axial fan 3503b (FIG. 7B). That is, an airflow path for sending air downward from the front side of the drying module 3000 via the inside of the drying module 3000 is formed.

The broken-line arrow of FIGS. 7A and 7B indicates the airflow path. The connection cables 4520, 5520, 6520, and 7520 are wired below a lower surface of the duct 3506. Accordingly, the connection cables 4520, 5520, 6520, and 7520 do not affect the airflow caused by the axial fans 3503a and 3503b, and thus the cooling effect is not lost. Further, as illustrated in FIG. 7C, a space for wiring the connection cables 4520, 5520, 6520, and 7520 is ensured below the duct 3506.

### Modification Example

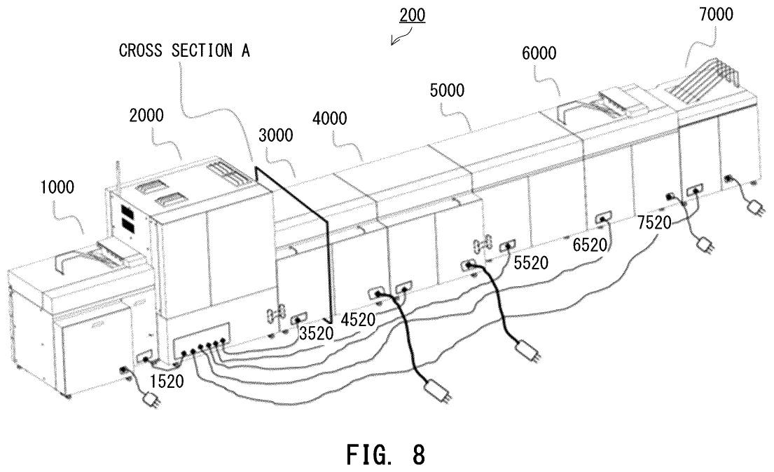

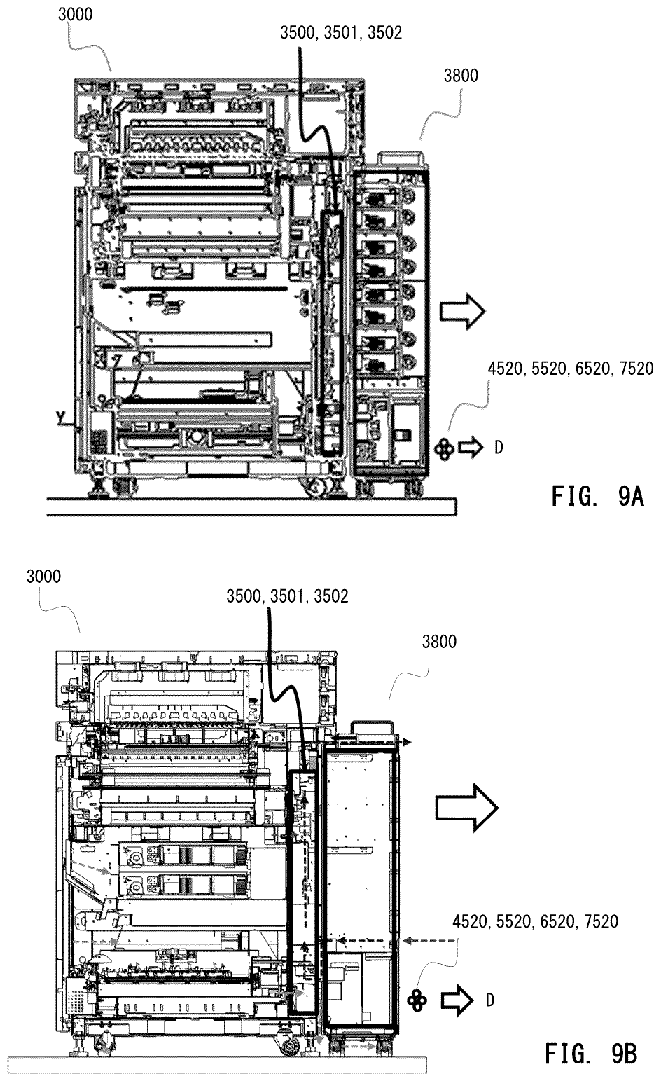

Description is now given of a connection configuration of an ink-jet recording system 200 in another mode. FIG. 8 is an explanatory view for illustrating the connection configuration of the ink-jet recording system 200 in the another mode. Parts similar to those of the ink-jet recording system 100 are denoted by the same reference symbols. The connection cables 1520, 3520, 4520, 5520, 6520, and 7520 from the respective modules are wired outside of the ink-jet recording system 200 to be collectively connected to the printing module 2000. FIGS. 9A and 9B are cross-sectional views of a position of a cross section A of the drying module 3000 as viewed from the printing module 2000 side. FIG. 9A is a cross-sectional view as viewed from the printing module 2000 side, and FIG. 9B is a view in which airflow paths indicated by arrows are added to FIG. 9A.

In order to get access to the main control board 3500, the first sub-control board 3501, and the second sub-control board 3502, the external electric component module 3800 may be separated from the drying module 3000. At this time, as illustrated in FIGS. 9A and 9B, the connection cables 4520, 5520, 6520, and 7520 may be moved in the arrow D direction. In a case where the electrical wire bundle 3504 electrically connecting the external electric component module 3800 to the drying module 3000 is removed and the screws used for physical connection are removed, the external electric component module 3800 can be separated from the drying module 3000. In this manner, access is allowed to the electric component unit (such as the main control board 3500, the first sub-control board 3501, and the second sub-control board 3502) inside of the drying module 3000.

The connection cables 4520, 5520, 6520, and 7520 may be moved before the external electric component module 3800 is moved. The connection cables 4520, 5520, 6520, and 7520 are each connected to the rear side of each module from the rear side of the printing module 2000 with one cable without using a relay. In order to move the connection cables 4520, 5520, 6520, and 7520, any one connection portion of each of the connection cables 4520, 5520, 6520, and 7520 may be separated. However, the removing and mounting work of the connection portion of each of the connection cables 4520, 5520, 6520, and 7520 is very troublesome.

There is also a method of providing the connection cables 4520, 5520, 6520, and 7520 with excess lengths so that the external electric component module 3800 is moved to escape by the amount of the excess lengths. However, in this method, places may be secured to place the excess lengths of the connection cables 4520, 5520, 6520, and 7520. As described above, in the ink-jet recording system 200, the work of separating the external electric component module 3800 is difficult.

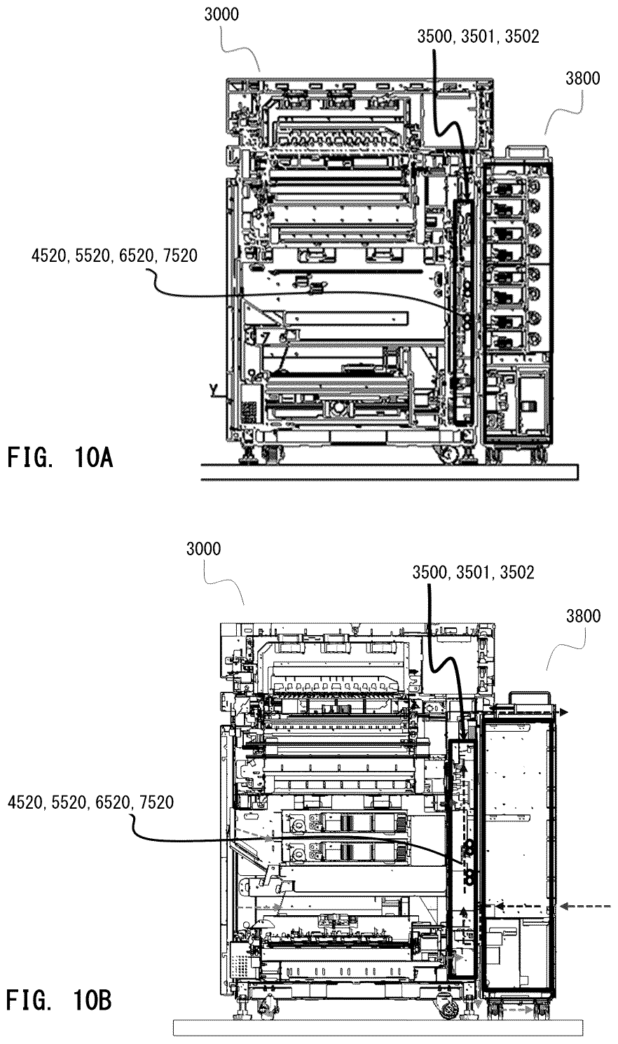

In view of the above, in the ink-jet recording system 200, the connection cables 4520, 5520, 6520, and 7520 are wired inside of the casing of each module. FIG. 10A and FIG. 10B are explanatory views for illustrating a configuration in which the connection cables 4520, 5520, 6520, and 7520 are wired inside of the casing of the drying module 3000. FIG. 10A shows a wiring state of the connection cables 4520, 5520, 6520, and 7520, and FIG. 10B is a view in which airflow paths indicated by arrows are added to FIG. 10A.

The connection cables 4520, 5520, 6520, and 7520 are arranged in a region on the rear side of the main control board 3500, the first sub-control board 3501, and the second sub-control board 3502, between those boards and the external electric component module 3800. The region between the external electric component module 3800 and the main control board 3500, the first sub-control board 3501, and the second sub-control board 3502 forms an airflow path for cooling the heat generated from mounted components on the mounting surfaces of the boards. Accordingly, the presence of the connection cables 4520, 5520, 6520, and 7520 in this region affects the efficient cooling of the electrical boards.

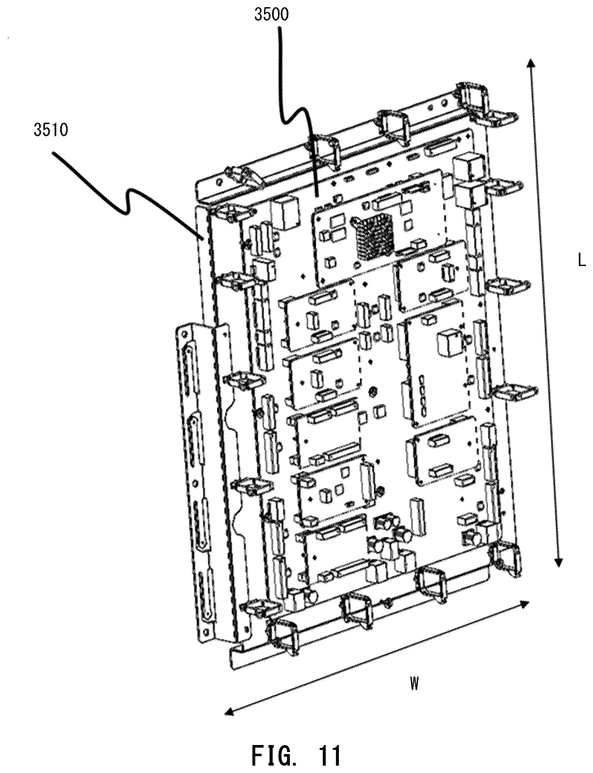

In a case where any one of the main control board 3500, the first sub-control board 3501, and the second sub-control board 3502 is failed, the failed component is replaced. For example, in a case where the main control board 3500 is failed, the main control board 3500 and a fixing member therefor are integrally replaced. FIG. 11 is a configuration view for illustrating the main control board 3500 and a board support 3510 that is the fixing member for the main control board 3500.

The board support 3510 has a vertical dimension L and a lateral dimension W. At the time of replacement of the main control board 3500, it is preferred that an obstacle be absent in the rear direction of the drying module 3000 in a range of the vertical dimension L and the lateral dimension W. In a case where the connection cables 4520, 5520, 6520, and 7520 are arranged in this region, the work of removing the connection cables 4520, 5520, 6520, and 7520 and the work of mounting the connection cables 4520, 5520, 6520, and 7520 are added to the work of replacing the main control board 3500. Accordingly, the maintenance time is greatly increased, and the maintenance efficiency is reduced.

### Relative Comparison of Two Systems

The ink-jet recording system 100 and the ink-jet recording system 200 are both similar in the technical advantage in that the cables can be appropriately arranged. Meanwhile, regarding the difficulty in movement of the connection cables 4520, 5520, 6520, and 7520, efficient cooling of the electrical board, and efficiency in component replacement, it can be said that the ink-jet recording system 100 is superior to the ink-jet recording system 200. Description is given of additional elements that contribute to the superiority of the ink-jet recording system 100.

As illustrated in FIGS. 5A and 5B, the connection cables 4520, 5520, 6520, and 7520 are wired below a projection region to the rear side of the electric component unit of the drying module 3000 (main body-side electric component unit). Accordingly, the main body-side electric component unit inside of the casing of the drying module 3000 can be easily replaced by moving the external electric component module 3800 on the exterior rear side of the drying module 3000, without moving the connection cables 4520, 5520, 6520, and 7520. The maintenance efficiency is improved as described above.

Moreover, the path for the connection cables 4520, 5520, 6520, and 7520 is secured below the duct 3506 inside of the casing of the drying module 3000, and thus a sufficient space is secured for the airflow path for cooling the main body-side electric component unit. The connection cables 4520, 5520, 6520, and 7520 do not affect the efficient cooling of the main body-side electric component unit obtained by the airflow.

The ink-jet recording system 100 has a function of conveying the sheet having an image printed thereon in all of the modules. For example, in the case of the drying module 3000, the drying module 3000 includes the decoupling unit 3200, the drying belt unit 3300, and the warm air blowing unit 3400 in an upper portion, and includes a return path conveyance unit 3450 to be used at the time of double-sided printing in a lower portion.

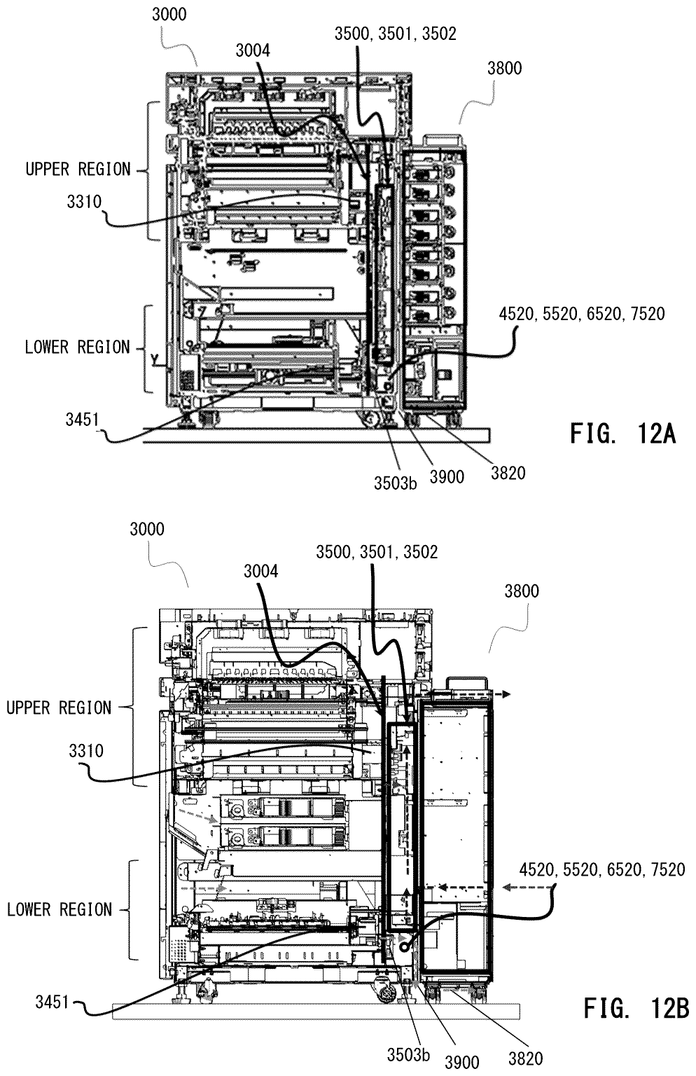

FIGS. 12A and 12B are cross-sectional views obtained by viewing the drying module 3000 from the printing module 2000 side at a cross section B of FIG. 3. FIG. 12A is a cross-sectional view of the drying module 3000 at the cross section B, and FIG. 12B is a view in which airflow paths indicated by arrows are added to FIG. 12A. The decoupling unit 3200, the drying belt unit 3300, and the warm air blowing unit 3400 are provided in an upper region of the drying module 3000. The return path conveyance unit 3450 used at the time of double-sided printing is provided in a lower region. The electric component unit (main control board 3500, first sub-control board 3501, and second sub-control board 3502) is arranged on the rear side of the rear side plate 3004. A motor 3310 of the drying belt unit 3300 and a motor 3451 of the return path conveyance unit 3450 are arranged on the front side of the rear side plate 3004.

The heat generation by the motor 3451 of the return path conveyance unit 3450 may be controlled so that the temperature inside of the drying module 3000 is prevented from rising. The heat generated by the motor 3451 is dissipated by providing an airflow path in the rear direction from the front side of the drying module 3000. Thus, as illustrated in FIG. 5A, an axial fan 3503b is provided in a lower part of the rear side plate 3004 close to the duct 3506 provided below the main body-side electric component unit of the drying module 3000. Air discharged by the axial fan 3503b passes through a gap 3900 between the drying module 3000 and the external electric component module 3800 so as to be discharged from the lower side of the bottom plate 3820 of the external electric component module 3800.

A cooling airflow path for the main body-side electric component unit of the drying module 3000 and a cooling airflow path for the motor 3451 of the return path conveyance unit 3450 are isolated from each other by the duct 3506. Accordingly, the dissipation of heat is efficiently performed in each place, and efficient cooling is allowed.

A wiring path for the connection cables 4520, 5520, 6520, and 7520 is isolated from the airflow path for the main body-side electric component unit of the drying module 3000 by the duct 3506. The cooling airflow path for the motor 3451 of the return path conveyance unit 3450 and the wiring path for the connection cables 4520, 5520, 6520, and 7520 share a part of the space. Thus, a new space may not need to be secured, and an increase in size of the apparatus can be suppressed. In a case where the connection cables 4520, 5520, 6520, and 7520 are wired near an exhaust port of the axial fan 3503b, efficient air exhausting cannot be performed. In order to achieve efficient air exhausting, it is preferred that the connection cables 4520, 5520, 6520, and 7520 be wired so as to be separated to the rear side as much as possible from the rear side plate 3004.

In the description above, description has been given of the configuration of the drying module 3000 provided with the external electric component module 3800, but, also in other modules, in a case where the external electric component module (external unit) is provided, the above-mentioned configuration can be applied. That is, the above-mentioned configuration is effective in a configuration in which, in an image forming system formed by coupling a plurality of modules, connection cables are collectively connected to a predetermined module from other modules or external units and an external module is provided on any one of the modules. In a case where a module to which the connection cables are collectively connected is the most upstream, in a module arranged on the upstream side having a short physical distance to the module, a connection cable from a module coupled on the downstream side or from an external unit thereof is wired inside of the casing. In a case where the above-mentioned configuration is adopted in such a case, the connection cable from the downstream module or the external unit does not affect the dissipation of heat of the module arranged on the upstream side. Further, even when the external unit is provided to the rear side of the module arranged on the upstream side, the access to the electric component module in the module does not affect the connection cable from the downstream module. Accordingly, the maintenance performance in the module is increased, and the dissipation of heat from the inside of the module is efficiently performed. Such a configuration is effective even when, to one external unit, other modules and other external units are collectively connected.

In this embodiment, the ink-jet recording system 100 has been described as the image forming system, but the image forming system may be configured to form an image by a system other than the ink-jet system, such as an electrophotographic system. In any case, the configuration of this embodiment is effective as long as the image forming system has a configuration which is formed of a plurality of modules and in which a connection cable is connected to one predetermined module from each of other modules. With such a configuration, the cables can be appropriately arranged even in a large-scale image forming system. Further, both of the maintenance efficiency and the heat dissipation efficiency from the inside can be provided.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of priority from Japanese Patent Applications No. 2024-059674, filed Apr. 2, 2024, and No. 2024-209797, filed Dec. 2, 2024, which are hereby incorporated by reference herein in their entirety.

What is claimed is:

1. An image forming system including a plurality of modules, the image forming system comprising:
a first module;
a second module, the first module and the second module being arranged along a conveying direction in which a sheet in the first module is conveyed;
a first electric component module coupled to the first module, the first electric component module being arranged, with respect to the first module, in a crossing direction that intersects the conveying direction;
a main body-side electric component unit provided in the first module;
a first electric component unit provided in the first electric component module; and
a connection cable provided between the first module and the first electric component module.

2. The image forming system according to claim 1, wherein the connection cable is arranged below a lower end of the main body-side electric component unit in a vertical direction crossing with both of the conveying direction and the crossing direction.

3. The image forming system according to claim 2, further comprising a duct configured to send air for cooling the main body-side electric component unit, the duct being arranged below the main body-side electric component unit in the vertical direction,
wherein the connection cable is arranged below a lower surface of the duct.

4. The image forming system according to claim 3, wherein the first electric component module has an intake for taking in air for cooling the first electric component unit.

5. The image forming system according to claim 1, wherein the first electric component module has an intake for taking in air for cooling the first electric component unit.

6. The image forming system according to claim 1, wherein the connection cable is connected to the second module.

7. The image forming system according to claim 6, further comprising:
a third module, the first module and the third module being arranged along the conveying direction so that the first module is arranged between the second module and the third module in the conveying direction;
a third electric component module coupled to the third module, the third electric component module being arranged, with respect to the first module, in the crossing direction; and
a third electric component unit provided in the third electric component module,
wherein the connection cable is connected to the third electric component unit.

8. The image forming system according to claim 1, further comprising:
a second electric component module coupled to the second module, the second electric component module being arranged, with respect to the second module, in the crossing direction; and
a second electric component unit provided in the second electric component module;
wherein the connection cable is connected to the second electric component unit.

9. The image forming system according to claim 8, further comprising:
a third module, the first module and the third module being arranged along the conveying direction so that the first module is arranged between the second module and the third module in the conveying direction;
a third electric component module coupled to the third module, the third electric component module being arranged, with respect to the first module, in the crossing direction; and
a third electric component unit provided in the third electric component module,
wherein the connection cable is connected to the third electric component unit.

10. The image forming system according to claim 9,
wherein the second electric component unit includes an overall control unit configured to totally control the first module, the second module, and the third module,
wherein the third electric component unit includes a main control board configured to control the third module, and
wherein the connection cable connects the overall control unit and the main control board to each other.
